(19) United States
(12) Patent Application Publication
(10) Pub. No.: US 2011/0072471 A1
(43) Pub. Date: Mar. 24, 2011

(54) Method of broadcasting digital data

(75) Inventors: Xavier BATTAS, Boulogne (FR); Jean-Luc Sully, Paris (FR)

(73) Assignee: QUADRILLE INGENIERIE, Paris (FR)

(21) Appl. No.: 12/842,567

(22) Filed: Jul. 23, 2010

(30) Foreign Application Priority Data
Jul. 24, 2009 (FR) 09 55222

(51) Int. Cl. H04N 7/20; G06F 15/16; H04N 7/173

(52) U.S. Cl. 725/67; 709/219; 725/98

(57) ABSTRACT

The present invention relates to a method of broadcasting a digital content in a unidirectional data transmission network comprising a transmitter system and a plurality of receivers, the digital content including primary data sent in variable amounts and thereby freeing bandwidth temporarily, in which method an additional digital content is transmitted from the transmitter system to at least one receiver using at least the temporarily freed bandwidth and said content is stored locally in at least one receiver.

The present invention provides a method of broadcasting digital data in a data transmission network, the transmitted data including primary data and an additional digital content.

The invention applies more particularly to broadcasting multimedia additional digital content, notably video files, for example recently-released cinema films, for which the user must pay an additional charge to view, in a manner similar to VOD (video on demand).

This broadcasting may be effected in a unidirectional network, for example a digital terrestrial television network or a satellite television network, or networks that are normally bidirectional, such as the Internet, where the primary data corresponds to broadcast television programs.

At present, VOD systems use “pull” mode transmission, with a digital content being broadcast at the request of a user by conventional “point to point” transmission between a transmitter system and receivers.

A user chooses an additional digital content from a catalogue available from a VOD service provider, for example, and the content may either be viewed by the user at the same time as it is broadcast or stored in a digital storage space of the receiver and viewed later.

That kind of broadcasting service implies a relatively cumbersome and costly network architecture and is generally deployed only in large conurbations, which limits access to the service.

There is a need to be able to broadcast an additional digital content, for example an additional digital content of large size, quickly, reliably, and securely in a data transmission network in which primary data is already in transit, especially since the introduction of receivers having a high storage capacity, for example in excess of 160 Gbytes, is liable further to increase interest in such additional contents.

Exemplary embodiments of the invention provide a method of broadcasting digital data, in particular video data, in a data transmission network, the network preferably being a digital terrestrial television network or a satellite television network, the network comprising a transmitter system and a plurality of receivers, the transmitted data including primary data sent in variable amounts and thereby freeing bandwidth temporarily, in which method additional digital content is transmitted from the transmitter system to at least one receiver using at least the temporarily freed bandwidth and said content is stored locally in at least one receiver.

By means of these exemplary embodiments of the invention, bandwidth available in the network and not used for broadcasting primary data is used to broadcast the additional digital content, which makes it possible to increase the amount of data broadcast without having to increase the size of the transmission network, in particular the bandwidth used, and without saturating the transmission network.

The additional digital content may be broadcast in the network at a bit rate determined as a function of the bandwidth available in the network not used for broadcasting primary data.

If bandwidth is available in the network even when it is broadcasting primary data, the additional digital content may be broadcast in the network using this available bandwidth, in contrast to prior art solutions in which it is necessary to wait for the available bandwidth to reach a predefined level before broadcasting the additional digital content. According to the invention, the additional digital content is broadcast independently of the amount of bandwidth available in the network.

The same additional digital content may be broadcast to all receivers of the network.

The size of the additional digital content file is not limiting on the invention, and may vary from a few hundred bytes to more than 2 Gbytes.

Broadcasting the additional digital content in the network need not require the presence of a dedicated channel, in contrast to the prior art solution described in US application 2003/0115294. The bandwidth available in the network even when it is broadcasting primary data need not be reserved for or allocated to a given receiver.

These exemplary embodiments of the invention make it possible in particular to optimize the use of the bandwidth of the network and are suitable for being deployed in unidirectional networks with no back channel, such as a digital terrestrial television network or a satellite television network. In the context of the invention, a “unidirectional network” is a network in which it is possible to set up communication only from a transmitter system to receivers and not also from the receivers to the transmitter system. One example of a non-unidirectional network is the Internet Protocol television (IPTV) network.

The additional digital content may be broadcast independently of a previous request from a user to obtain the additional digital content. The aim of such a request is to obtain the additional digital content before a predefined date or within a time period starting from the request being sent, which period is less than one day or a few days, for example, in particular less than one hour or a few hours, in particular less than one hour.

These exemplary embodiments of the invention make it possible for the additional digital content to be received by the receiver even if the receiver is not being used by the user. The additional digital content is broadcast in “push” mode, for example, in particular within a “point to multipoint” type broadcast network, i.e. the additional digital content may be broadcast at the initiative of the transmitter system. The available bandwidth may thus be used to push the additional digital content towards the receivers in the network.

In this way, the additional digital content is advantageously broadcast only if the transmitter system is informed of the temporary availability of bandwidth in the transmission network.

The additional digital content is broadcast by the transmitter system as a function of a forecast of bandwidth availability (“bandwidth window”) in the transmission network linked to broadcasting the primary data, for example. The forecast comes from an operator of the transmission network, for example, in particular the operator of one or more television channels. Alternatively, this broadcast window is determined by the transmitter system, which may be dynamically slaved to the availability of bandwidth in the network. To this end the transmitter system may be configured to detect available bandwidth in the network and to replace padding packets occupying that available bandwidth with packets conveying the additional digital content. In this way the use of the network may be optimized as well as the average revenue per user (ARPU).

An additional digital content broadcast bandwidth window that results from bandwidth being freed in the transmission network may be of the order of a few minutes, a few tens of minutes, or a few hours, for example. This time bandwidth window may be substantially repeated from one day to another or it may be updated dynamically, for example at the initiative of the transmission network operator or by the transmitter system, which then effects a dynamic search for available bandwidth.

For example, the transmitter system is configured to search the network for available bandwidth not used for transmitting primary data and to contact the operator of the transmission network in order to have the available bandwidth found in this way assigned to it for transmitting the additional digital content.

In the situation of satellite television, the broadcast bandwidth window may be created by a change of transponder.

The data transmission network may include at least one back channel from at least one receiver to the transmitter system, which may make it possible to guarantee routing of all the additional digital content to that receiver. This back channel comprises the Internet or the telephone network, for example.

In a first implementation of the invention, the additional digital content is broadcast in the transmission network at a fixed bit rate.

In a second implementation of the invention, the additional digital content is broadcast continuously in the data transmission network at a variable bit rate, which makes it possible to adapt broadcasting of the content to the bandwidth availability in the transmission network changing as a result of broadcasting primary data. Primary data is not transmitted during the night, for example, and the bit rate of the broadcast additional digital content is increased during that period. This applies to primary data corresponding to television programs broadcast on a children's channel, programs on which channel may be interrupted between 1 o'clock and 6 o'clock in the morning, for example.

In another implementation, the additional digital content is broadcast in the data transmission network discontinuously. For example, broadcasting of the content is continued after an interruption as soon as bandwidth is again available in the network, which enables more refined matching of the broadcasting of the additional content to the availability of the network as a result of the variability of the broadcast primary data stream.

Broadcasting of the additional digital content is continued by broadcasting only packets of the content not yet broadcast, for example, which makes it possible to avoid rebroadcasting all of the content already transmitted to the receiver and causing unnecessary congestion in the transmission network.

There is no time limit on broadcasting of the additional digital content being interrupted.

If the transmission network is a multichannel network, the digital content may be broadcast as a function of the bandwidth available on each channel, the additional digital content being broadcast on one or more channels, and it being possible to choose a channel as a function of the occupancy of the channel by primary data.

After broadcasting is interrupted, the additional digital content may be broadcast on at least one channel different from the channel that was being used to broadcast it before the interruption, for example only on channels different from those used before broadcasting was interrupted.

The transmission network may include at least two sub-networks and the broadcasting of the additional digital content to the receiver by the transmitter system may be adapted as a function of the bandwidth available in each sub-network, broadcasting being effected in only one of the sub-networks or alternatively in different proportions in each of the sub-networks, for example.

The receiver includes a digital storage space and the additional digital content may include data relating to the fraction of the storage space allocated to storing the additional digital content, which makes it possible for the transmitter system to manage use of the digital storage space of the receiver. The receiver may be configured so that it may be remote-controlled by data included in the additional digital content.

The additional digital content may include data relating to the management of said content by the receiver and at least part of the additional digital content may be stored in or deleted from the digital storage space of the receiver as a function of said data, which allows the transmitter system to manage the additional digital content stored in the digital storage space of the receiver. The transmitter system may update the additional digital content stored in the digital storage space of each receiver, for example. This makes it possible to make room for new files by eliminating the oldest files from the list of files available for consulting, for example.

The additional digital content may, in the context of use for VOD, include multimedia files, in particular films or video clips.

The receiver may apply at least one multimedia file acceptance filter as a function of a user profile so that only multimedia files not rejected by the filter are stored by the receiver, which makes it possible for only files likely to be of interest to the user to be stored in the receiver. The filters have parameters set by the user by means of a user interface accessible to the user, for example. Alternatively, these filters have parameters set by an entity separate from the user, in particular based on a study of the user's behavior. The filter parameters may be set remotely, for example when a user logs onto a user account, for example via the Internet.

The data transmission network is a digital terrestrial television network (DTT), for example, a satellite television network or an Internet Protocol television (IPTV) network. The invention is of particular benefit for the first two of the above kinds of network.

The additional digital content that is broadcast is for example a multilingual content, which may make it possible for this content to be transmitted only once, independently of the user's language. This is of particular benefit in the context of the satellite television network.

The additional digital content may be stored in the digital storage space (“hard disk”) of a receiver in a manner that is transparent for the user of the receiver, i.e. recovery of data relating to the additional digital content and storage thereof may be effected independently of any request to that effect submitted by the user, as soon as bandwidth is available in the transmission network and provided that the content is not rejected by the filters referred to above.

Recovery of data relating to the additional digital content and storing it in the digital storage space of the receiver or receivers may be effected without having to program the receiver to start up at a predefined time to store said content.

The additional digital content transmitted to a user may be encrypted and stored in the receiver using an encryption key specific to the receiver, for example.

The receiver includes a TV output, in particular a composite video, SVideo, or HDMI connector, for example, or any other type of digital output.

The receiver includes an internal hard disk, an external hard disk or a flash memory, for example, consisting of a set top box, for example.

The additional digital content may be broadcast independently of the Internet. The invention may thus make it possible to dispense with using the Internet.

Other exemplary embodiments of the invention provide a method of broadcasting digital data, in particular video data, in a data transmission network, the network preferably being a digital terrestrial television network or a satellite television network, the network comprising a transmitter system and a plurality of receivers, the transmitted data including primary data transmitted in variable amounts and thereby freeing bandwidth temporarily, in which method additional digital content is transmitted from the transmitter system to at least one receiver using at least the temporarily freed bandwidth and said content is stored locally in at least one receiver, this additional digital content being transmitted at a bit rate determined as a function of available bandwidth in the network not used for broadcasting primary data.

The other above-mentioned exemplary embodiments may be applied to unidirectional networks and other networks such as Internet Protocol television (IPTV) networks.

Other exemplary embodiments of the invention provide a system for broadcasting additional digital content from at least one transmitter system to at least one receiver in at least one data transmission network, the network preferably being a digital terrestrial television network or a satellite television network, the transmitted data including primary data transmitted at a variable bit rate and thereby freeing bandwidth temporarily, the broadcasting system being configured to transmit additional digital content from the transmitter system to at least one receiver using the temporarily freed bandwidth.

Such a system may have some or all of the features of any of the above broadcasting methods. It may in particular be configured to transmit the additional digital content at a bit rate determined as a function of bandwidth available in the network not used for broadcasting primary data.

The invention can be better understood on reading the following description of non-limiting implementations of the invention given by way of example and with reference to the appended drawings, in which:

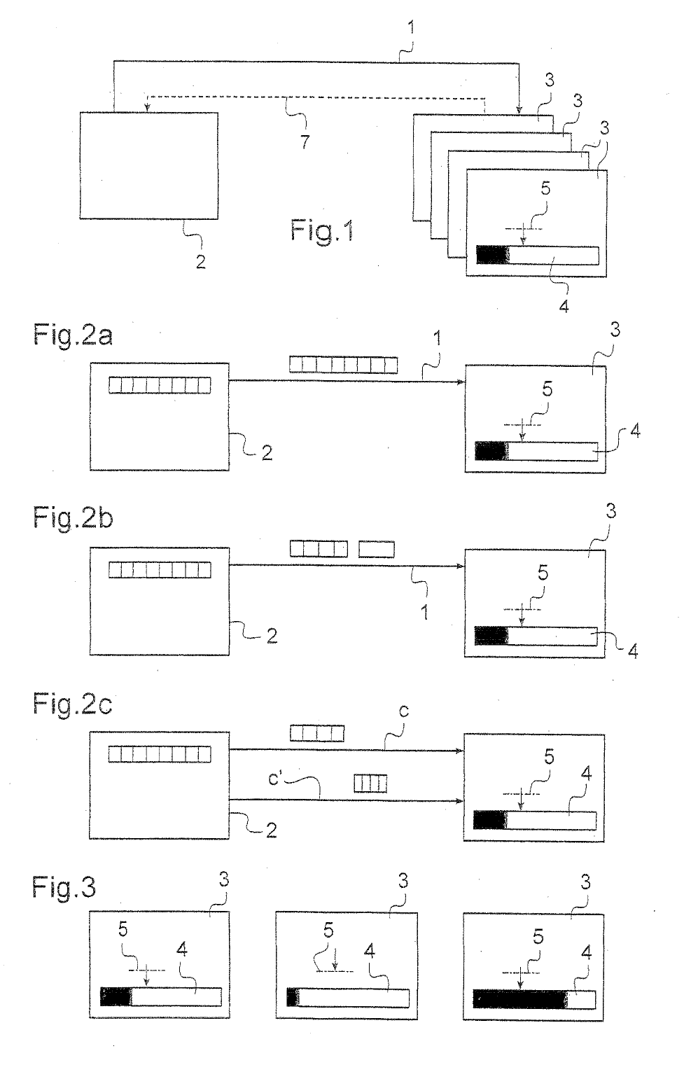

FIG. 1 is a diagram of one example of a data transmission network of the invention;

FIGS. 2a to 2c show different examples of broadcasting an additional digital content;

FIG. 3 shows the processing by a receiver of an additional digital content received by that receiver;

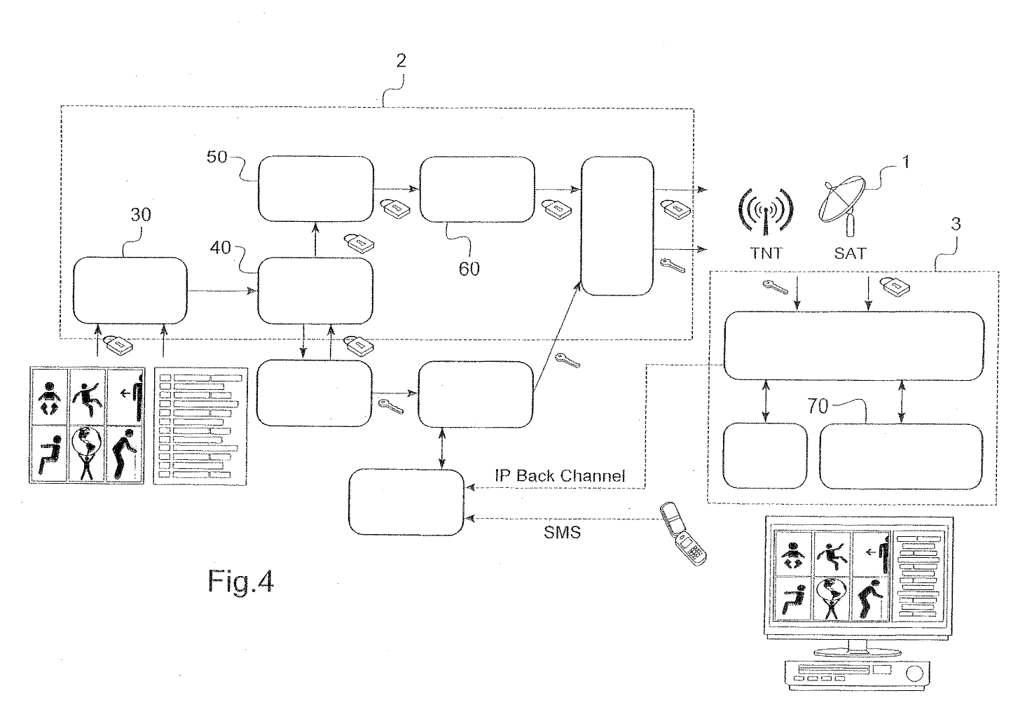

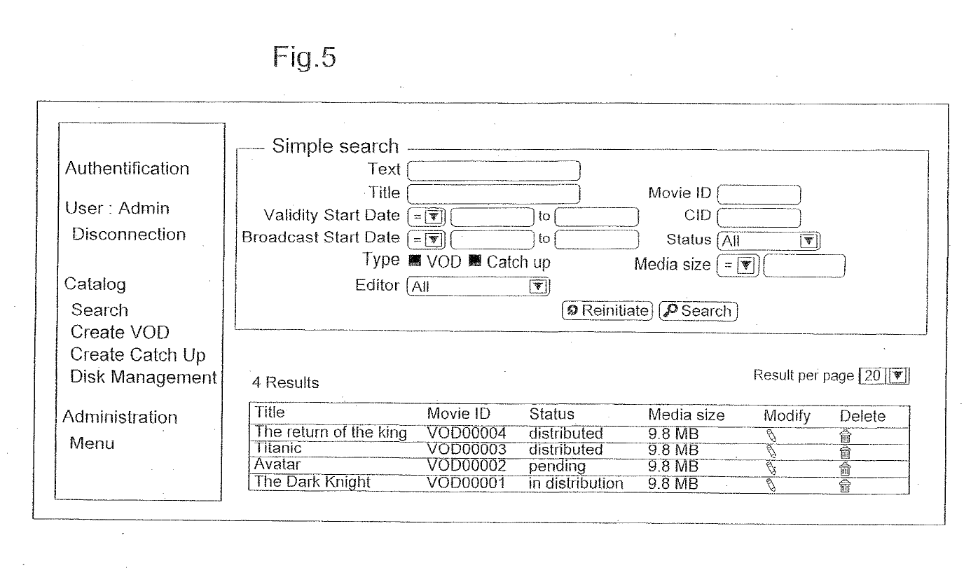

FIG. 4 is a diagram of a network in which the invention may be used;

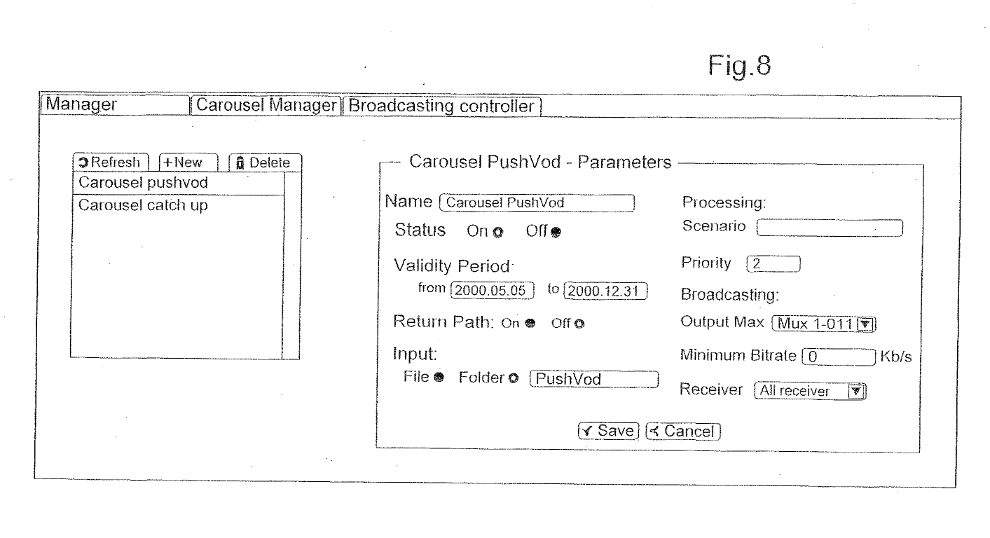

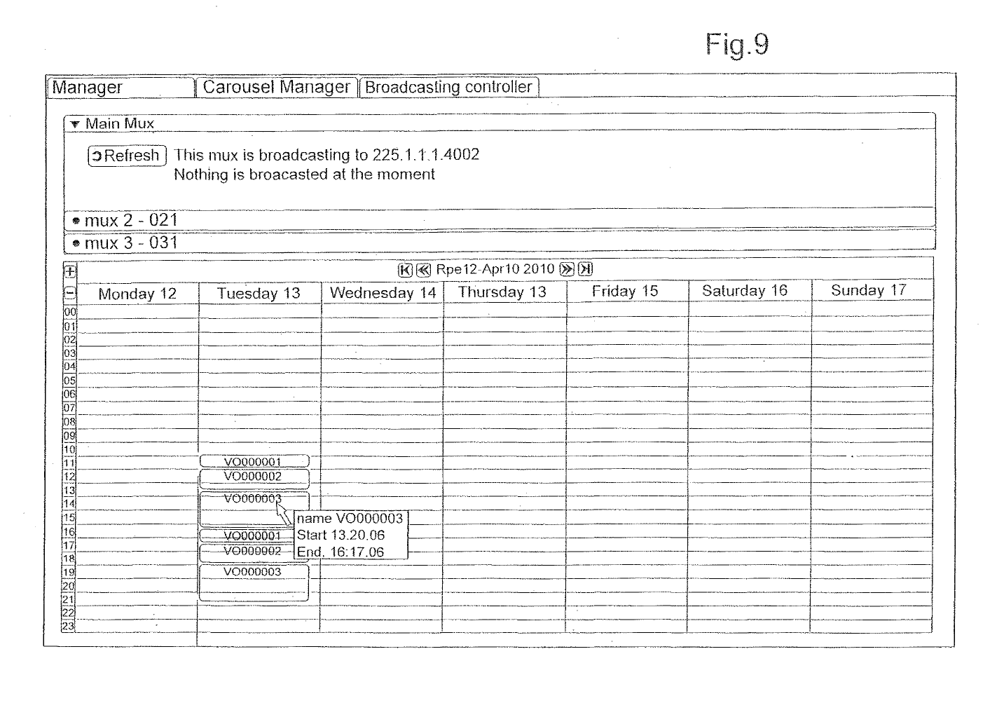

FIGS. 5 to 9 are user interface screenshots of components of the transmitter system; and

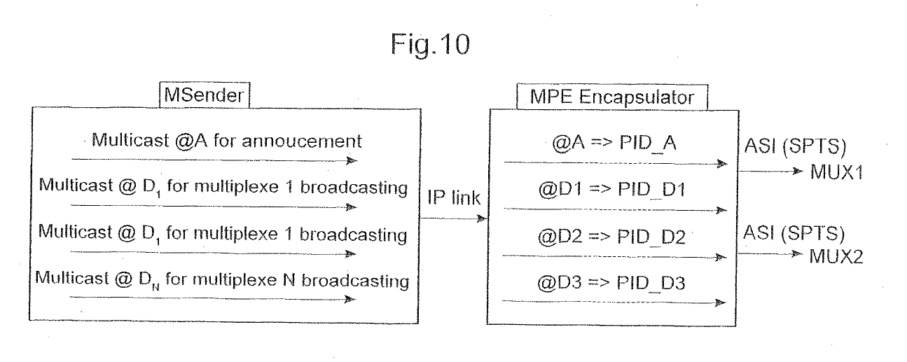

FIG. 10 represents diagrammatically steps prior to broadcasting the additional digital content in the network.

FIG. 1 shows a data transmission network 1 of a first implementation, of the invention. This network is a digital terrestrial television network, a satellite television network or an Internet Protocol television (IPTV) network, for example. The transmission network 1 is a multichannel network, for example. The transmission network 1 includes a transmitter system 2 and a plurality of receivers 3.

The network 1 transmits primary data, for example TV programs, and additional digital content. The additional digital content includes multimedia files such as films, for example, which files may constitute multilingual contents. These files may be to the MPEG2, H264, SD, or HD format. The additional digital content may comprise files such as an electronic program guide (EPG), advertising or video games.

If the additional digital content includes multimedia files, it may also include images associated with other multimedia files from a catalog available in the network and/or a trailer and/or an advertisement, in particular a multimedia file present in the additional digital content.

In the example described here the additional digital content also includes data relating to management of the additional digital content by the receiver 3, reception of this data by the receiver leading to storage or deletion of files in the memory space of the receiver as a function of said data, for example. Descriptive data is associated with each file of the additional digital content and, when the file is a film, includes its title, genre, author, actors, production date, language, a synopsis, the duration of the film, parental guidelines, or a start date and/or an end date of the file beyond which the file will be deleted from the storage space of the receiver, for example.

A parameter defining the maximum number of times a file may be read may also be associated with the file.

The additional digital content may be transmitted in encrypted form and storage may entail local encryption, for example encrypting a file with an encryption key specific to each receiver as described in French patent FR 2 846 831.

The transmitter system 2 in the example described here is a service provider, for example a TV channel, or an operator providing a video on demand service.

The transmitter system 2 is shown in more detail in FIG. 4, which shows that the transmitter system 2 includes a content manager 30, a sending manager 40, and a server 50.

The content manager 30 is accessible via a Web browser and may have some or all of the following functions:
document indexing, this function enabling input of descriptive data associated with one or more multimedia files;
data management, this function enabling combination of a multimedia file, e.g. a video file, with additional multimedia files, e.g. additional video files;
associated document management, this function enabling association of texts or photos in different formats, e.g. PDF, JPEG, text or other formats when broadcasting a video file;
catalog management, this function using an administration module to list the files on offer, for example;
edition management, this function enabling association of data such as a priority level with a multimedia file to be broadcast;
rights management, this function enabling indication of commercial parameters necessary from the point of view of broadcasting the multimedia file, such as its price and availability as a function of the date and time or the target public, for example to prevent children receiving additional digital content reserved for adults; and/or
management of the digital storage space of one or more receivers 3, this function being described below.

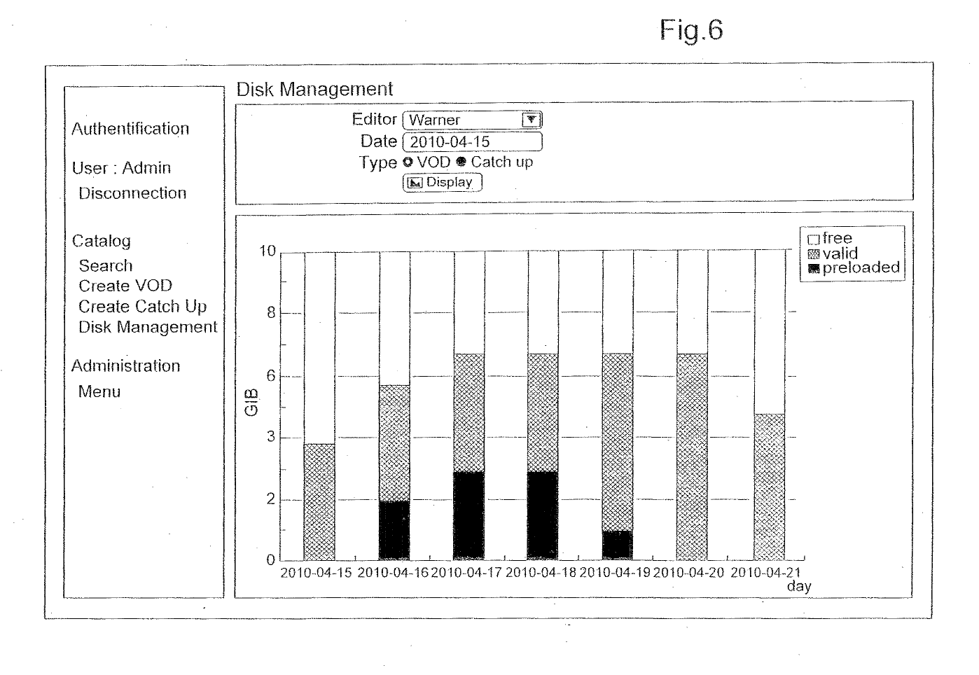

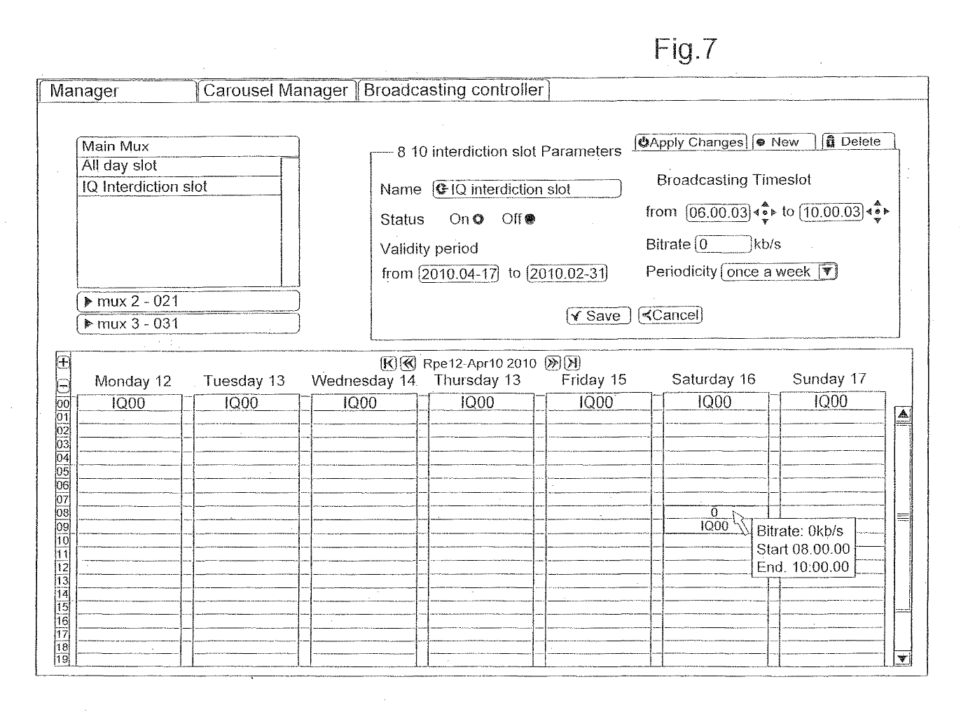

This content manager may be accessible via a user interface of language and/or alphabet that may be selectable. FIGS. 5 and 6 are screen shots of examples of such a user interface.

The sending manager 40 is a program configured to forecast the transmission of the additional digital content as a function of the bandwidth available in the network not used for transmitting primary data.

The bandwidth available in the network is known to the transmitter system 2, for example by means of information supplied by the network operator. Alternatively, the sending manager 40 is configured to search dynamically for any bandwidth in the network not used for transmitting primary data. Parameters may be set to configure the operation of the sending manager 40 by defining for a broadcast window the content to be transmitted, the bit rate at which the content is to be transmitted, and, if necessary, the evolution of that bit rate over time. Setting the parameters of the sending manager 40 in this way may further include defining conditions for retransmitting the additional digital content in the event of a transmission failure, conditions for stopping broadcasting of the content or a priority level associated with the additional digital content.

FIGS. 7 to 9 show screenshots of a user interface of a sending manager 40 of one exemplary embodiments of the invention.

In the present example the server 50 is adapted to operate in “push” mode to broadcast the additional digital content in the network, for example using the VFDP V2 protocol. Access to the server 50 is possible via an application programming interface (API), for example, which the sending manager 40 is able to access to monitor the tasks effected by the server 50.

The bit rate at which the server 50 broadcasts the additional digital content may be adjusted dynamically, in particular in real time. Broadcasting the additional digital content may be interrupted and resumed.

If the transmission network is a DVB network, the additional digital content sent by the server 50 may take the form of IP packets that are encapsulated by a module 60 into TS encapsulating packets according to the MPE protocol.

The receivers 3 are decoders, for example, also known as set-top boxes (STB) and including an internal or external hard disk or other mass storage device defining a digital storage space 4 with a capacity in the range 160 Gbytes to 250 Gbytes, for example, although this range is not limiting on the invention. These receivers may have an internal or external hard disk or a flash memory.

The receivers may have outputs supplying the video and digital or analog audio, for example an HDMI output.

The network 1 is for example a unidirectional network with no back channel enabling a receiver to send information to the transmitter. Alternatively, the network 1 does include such a back channel 7.

The receivers 3 may include, as shown in FIG. 3, one or more filters 5 having parameters set by the user of the receiver 3 as a function of information from a user profile, these filters enabling the user to accept only files in the additional digital content received from the transmitter system 2 that relate to their interests. If a file is not rejected by the filter or filters 5, it may be stored in the storage space 4 of the receiver, in particular after being decrypted.

A fraction of the digital storage space is dedicated to storing an additional digital content, and this fraction may vary from one receiver 3 to another, as can be seen in FIG. 3.

The receiver 3 may include a user interface including means for displaying a list of files obtained from the additional digital content received and means for modifying parameters relating to the reception of the additional digital content and/or for selecting files received in this way. The user interface may include a graphical interface of the HTML, Bluestreak, Flash, or other type. Only valid files, i.e. files associated with a validity date that has not expired, may be displayed on this graphical interface.

The receiver 3 includes a module 70 in the form of downloaded software for reconstituting content sent by the server 50. The content may have been transmitted to the receiver 3 on a plurality of occasions because the bandwidth was not sufficient to enable transmission of all the additional digital content at the same time. The module 70 cooperates with the content manager 30 in the context of the function for managing the digital storage space of the receiver 3.

The user interface may include a keypad and a screen, for example the screen on which programs are viewed. The keypad is a remote control, for example. Alternatively, the user interface may include speech recognition means.

By means of the user interface, the user of the receiver 3 is able to view some or all of the files available in the storage space of the receiver 3 and data relating to the management of each file of the additional digital content. This data may enable day-to-day management of files broadcast via the transmission network, for example management of the files each day at a time that is a parameter the user can set. The receiver 3 includes for example a processing unit that includes one or more electronic circuit cards and is configured to delete files for which the expiry date has been reached or the oldest recorded files that have not been viewed for a predetermined time.

The data relating to managing the content may also lead to deletion of all the files stored in the digital storage space of the receiver.

The user may employ the user interface to modify the language of a received file, for example. Alternatively, the user may use the interface to modify the parameters of the filter or filters described above. The user interface may also be configured to enable a user to view a received file, the user interface screen including a bar giving the user the number of the file and an identifier that the user must transmit to the server center, for example via an interactive voice server, to obtain the rights to view the file, for example.

In one implementation of the invention, each receiver 3 may be connected to a back channel transporting user transactions to a service center having the interactive voice server role referred to above. The server may use either this back channel or the transmission network to route these rights to the user. The back channel includes an Internet connection, for example.

Examples of broadcasting additional digital contents in the network 1 are described below with reference to FIG. 2.

The additional digital content is broadcast by the transmitter system 2 as a function of a forecast bandwidth availability in the transmission network, linked to the broadcasting of the primary data. These forecasts are communicated to the transmitter system by a transmission network operator via a dedicated interface. Alternatively, this forecasting is effected by a transmitter system operator by consulting the electronic program guide (EPG).

If the transmission network is the terrestrial digital network, the forecast takes into account periods during which some channels are not transmitted. The forecast is updated at the initiative of the transmission system operator or by the transmitter system itself, and may concern each multiplex of the network, and the available bandwidth may be assigned to broadcasting the additional digital content for each multiplex.

If the transmission network is a satellite television network, the forecast may relate to a plurality of transponders.

Broadcasting the additional digital content corresponds to a time window with a duration from one minute to several tens of minutes. Alternatively, the broadcasting time window may be of the order of a few hours.

In the FIG. 2a example, the available bandwidth in the network 1 because of broadcasting primary data enables the transmitter system 2 to broadcast all of an additional digital content, in particular all of a video file, during the time window at the same time and at a fixed bit rate.

In the FIG. 2b example, the available bandwidth in the network 1 enables the transmitter system 2 to broadcast all of the additional digital content, in particular all of the video file, at the same time, but at a bit rate that varies as a function of the freed bandwidth in the network.

In the FIG. 2c example, the additional digital content is broadcast non-continuously, broadcasting being interrupted because of the non-availability of bandwidth in the network when a plurality of packets have already been broadcast. The interruption may be of the order of a few minutes, several hours, or even several days. Broadcasting of the digital content resumes when bandwidth is again available in the transmission network.

In the FIG. 2c example, the packets are transmitted on a channel c before the interruption and, on resuming broadcasting, these packets are transmitted on another channel c′, but there is no departure from the scope of the present invention if broadcasting resumes on the same channel as was used before the interruption.

Another alternative is for the network to include two sub-networks and for broadcasting to be effected via only one of the sub-networks or in different proportions via each of the sub-networks as a function of the available bandwidth in each sub-network.

On resumption of broadcasting, only packets not yet sent to it are sent to the receiver.

At the end of transmission of a multimedia file, the transmitter system 2 may transmit a new multimedia file to one or more receivers 3 as a function of the available bandwidth in the transmission network. Alternatively, the transmitter system 2 may rebroadcast the same additional digital content, for example the same file, in the transmission network as a function of quality of service objects to be met, technical constraints and/or the topology of the transmission network, such as the packet loss concept.

Alternatively, once an additional digital content has been broadcast, the transmitter system 2 may go to a waiting state. A sequence for loading and broadcasting an additional digital content in the network represented in FIG. 4 is described below. The network is a digital terrestrial television network, such as the DTT, SAT network, or an IP MPLS network.

An additional digital content from each content provider may be loaded into the transmitter system 2 via a secure connection to an FTP server. The content loaded may comprise, in addition to one or more multimedia files, metadata associated with that multimedia file or files. The content provider may receive an acknowledgement message when the content has been loaded into the transmitter system 2. If necessary, the content loaded at a validity date that has already expired or that is about to expire imminently and a message inviting the content provider to modify it may be sent. The content manager 30 may then publish the content loaded in this way; either automatically on the publication date appearing in the loaded content or manually if there is no publication date in the loaded content.

The loaded content may then be formatted by the sending manager 40 with a view to the server 50 broadcasting it in the network. This shaping step consists in encrypting the multimedia file or files present in the additional digital content and grouping in said content all the other files referred to above that may be associated with the multimedia file(s).

This additional digital content may be broadcast in the network as a function of a plurality of criteria, including priority levels associated with the additional digital content, a match between the in-band availability and the network resources necessary for broadcasting the content, and the size of the additional content.

During broadcasting of the content, the user interface of the content manager 30 or the sending manager 40 may display information relating to that broadcast, for example the bit rate of the broadcast or an identifier associated with the content.

The bit rate at which the additional digital content is broadcast may be modified dynamically, as explained above. At times when there is no bandwidth available for broadcasting the additional digital content, broadcasting may be interrupted and then resume once bandwidth not used to broadcast primary data becomes available again, if necessary using another multiplex. In the example described here, on resuming broadcasting of the additional digital content only packets of the content not yet transmitted are broadcast.

The module 70 may operate continuously or non-continuously. This module is configured to listen to messages in the network announcing the transfer of additional digital content distributed by some or all multiplexes of the network. As soon as the broadcasting of a new additional digital content is announced, the module 70 may analyze the announcement message in order to determine whether the additional digital content is relevant to the receiver 3 of which it is part.

This determination is based on one of the following criteria, for example:
the receiver belonging to an additional digital content broadcast list, if the said list exists and the additional digital content is not intended to be broadcast to all the receivers 3 of the network;
no prior reception of this additional digital content;
a match between keywords associated with the additional digital content and the filter or filters 5 described above; and
on the presence of sufficient room in the digital storage space of the receiver to store this content, if necessary after deleting from this digital memory space multimedia files whose validity date has passed, for example on the instructions of the module 70. On deleting multimedia files, all other files forming part of the additional digital content and associated with the multimedia files may also be deleted from the digital storage space of the receiver 3, for example XML files. Viewing by the user of the receiver of multimedia files broadcast in the additional digital content is conditional on the user taking out a subscription, on the user using tokens, a predefined number of which have previously been assigned to them, or on payment on demand, for example. The payment-on-demand option may require the presence of a back channel in the network, for example via the Internet or a telephone network.

The broadcasting of an additional digital content to a receiver 3 may be preceded by an announcement message, as explained above, for example a message of the VFDP type sent by the server 50. This announcement message may include instructions to the receiver in relation to starting, ending, suspending and resuming broadcasting of the additional digital content. For each new additional digital content that may be broadcast in the network, the announcement message may include information such as the length of the multimedia file, a key word, a broadcast list and, if the network includes a plurality of channels, the channel used to send transport messages.

These announcement messages may be broadcast on a dedicated channel, for example a channel associated with an address or a multicast port or a PID/TSID identifier.

Transport messages may be sent by the server 50 for broadcasting the payload. The size and the bit rate of these transport messages may be determined by the server 50 as a function of application parameters and the bit rate of these transport messages may be modified during broadcasting. In a similar way to announcement messages, transport messages may be broadcast on a dedicated channel obtained by means of the announcement messages, this dedicated channel being associated with an address or a multicast port or a PID/TSID identifier, for example.

As soon as broadcasting of the additional digital content by the transmitter system 2 has begun, the receiver 3 may listen to the channel used for sending announcement messages. If an announcement message concerns the receiver, the receiver may reconstruct the additional digital content received by storing and rearranging the received packets.

As mentioned above, the additional digital content may be announced by keywords, which may enable the receiver to be sure that the files received do correspond to the keywords previously received.

The announcement and transport messages may be sent via the downlink connection and the stream may correspond to a multicast IP address.

In the context of broadcasting the additional digital content, the server 50 sends VFDP messages and UDP or TCP packets to a multicast address. Using TCP mode may make it possible to slave the broadcasting bit rate to the maximum values available on the MPE encapsulator side.

As shown in FIG. 10, referencing may be effected between a multicast address and a multiplex/PID pair, which may enable broadcasting packets in different multiplexes in order to optimize the available bandwidth.

Examples of the components of the transmitter system 2 are given below. The content manager 30 and the sending manager 40 may be based on the following versions of the php APACHE® web server, the APACHE TOMCAT® server, and the MySQL database:
APACHE® web server version 1.3;
APACHE TOMCAT® server version 6;
php version 5;
MySQL version 4.

The servers use the LINUX® operating system, for example.

The above servers are HP DL 380 G5 Intel® Xeon® quad core 3, 16 GHz, 2 U, 4 Gbyte RAM DD 500 Gbyte servers, for example.

The server 50 uses a WINDOWS® operating system and is an HP DL 360 G5 INTEL® XEON® quad core 2, 33 GHz, 1 U, 2 Gbyte RAM DD 150 Gbyte server, for example.

The servers may be redundant. The content manager 30 and the sending manager 40 may be “hot-plug” applications on these servers.

In the event of failure of broadcasting of the additional digital content by the server 50, the sending manager 40 may request a back-up server to take over broadcasting said content.

The expression “comprising a” should be understood as meaning “comprising at least one” unless the contrary is specified.

1. A method of broadcasting digital content in a unidirectional data transmission network comprising a transmitter system and a plurality of receivers, the digital content including primary data sent in variable amounts and thereby freeing bandwidth temporarily, in which method additional digital content is transmitted from the transmitter system to at least one receiver using at least the temporarily freed bandwidth and said content is stored locally in at least one receiver.

2. A method according to claim 1, the additional digital content being broadcast independently of a previous request to obtain the additional digital content.

3. A method according to claim 1, wherein the additional digital content is broadcast in the transmission network at a fixed bit rate.

4. A method according to claim 1, wherein the additional digital content is broadcast continuously in the data transmission network at a variable bit rate.

5. A method according to claim 1, wherein the additional digital content is broadcast non-continuously in the data transmission network and, in the event of the broadcasting of the additional digital content being interrupted, broadcasting resumes after reception of information relating to the bandwidth available in said network.

6. A method according to claim 5, wherein, on resuming broadcasting of the additional digital content, only packets of the additional digital content that have not yet been broadcast are broadcast.

7. A method according to claim 1, wherein the network is a multichannel network in which the additional digital content is broadcast as a function of the available bandwidth on each channel.

8. A method according to claim 6, wherein broadcasting in the network resumes on at least one channel different from the channel or channels used to broadcast the additional digital content before the interruption.

9. A method according to claim 1, wherein the receiver includes a digital storage space and the additional digital content includes data relating to the fraction of the storage space to be allocated to storing the additional digital content.

10. A method according to claim 1, wherein the additional digital content includes data relating to the management of said content by the receiver and at least part of the additional digital content is stored in or deleted from the digital storage space of the receiver as a function of said data.

11. A method according to claim 1, wherein the additional digital content includes multimedia files.

12. A method according to claim 11, wherein at least one multimedia file acceptance filter is applied by the receiver as a function of a user profile and only multimedia files not rejected by the filter are stored by the receiver.

13. A method according to claim 12, wherein the data transmission network includes at least two sub-networks and broadcasting of the additional digital content by the transmitter system to the receiver is adapted as a function of the available bandwidth in each sub-network.

14. A method according to claim 13, wherein the data transmission network is a digital terrestrial television network or a satellite television network.

15. A method according to claim 1, wherein the transmitter system is slaved dynamically to the availability of bandwidth in the network.

16. A system for broadcasting additional digital content from at least one transmitter system to at least one receiver in at least one unidirectional data transmission network, the transmitted data including primary data transmitted at a variable bit rate and thereby freeing bandwidth temporarily, the system being configured to transmit additional digital content from the transmitter system to at least one receiver using the temporarily freed bandwidth.

17. A method of broadcasting digital data in a data transmission network comprising a transmitter system and a plurality of receivers, the transmitted data including primary data transmitted in variable amounts and thereby freeing bandwidth temporarily, in which method additional digital content is transmitted from the transmitter system to at least one receiver using at least the temporarily freed bandwidth and said content is stored locally in at least one receiver, this additional digital content being transmitted at a bit rate determined as a function of available bandwidth in the network not used for broadcasting primary data.
